(19) United States
(12) Patent Application Publication
(10) Pub. No.: US 2025/0137661 A1
(43) Pub. Date: May 1, 2025

(54) HEATING COOKER

(71) Applicant: SHARP KABUSHIKI KAISHA, Sakai City (JP)

(72) Inventors: Mariko YACHI, Sakai City (JP); Shinji Asami, Sakai City (JP); Masayuki Iwamoto, Sakai City (JP)

(21) Appl. No.: 18/926,849

(22) Filed: Oct. 25, 2024

(30) Foreign Application Priority Data
Oct. 31, 2023 (JP) 2023-186339

(51) Int. Cl. F24C 15/32; H05B 3/44

(52) U.S. Cl. CPC F24C 15/325; H05B 3/44; H05B 2203/016

(57) ABSTRACT

A heating cooker includes a heating cooking compartment, a door, and a heater unit. The heating cooking compartment has an opening in a front wall. The door opens and closes the opening. The heater unit is disposed on an upper wall of the heating cooking compartment. The heater unit includes a heater configured to generate heat, a heat reflection plate covering an upper side of the heater, and a thermal shield plate covering an upper side of the heat reflection plate. An air layer is provided between the heat reflection plate and the thermal shield plate.

### BACKGROUND OF THE INVENTION

### 1. Technical Field

The present disclosure relates to a heating cooker. This application claims the benefit of priority to Japanese Patent Application Number 2023-186339 filed on Oct. 31, 2023. The entire contents of the above-identified application are hereby incorporated by reference.

### 2. Description of the Related Art

JP H10-205772 A discloses a heating cooker. The heating cooker disclosed in JP H10-205772 A includes a heating compartment, a tubular heater, a reflection plate, and a heat insulating layer. The heating compartment houses a heating-target object. The tubular heater is provided above the heating compartment. The reflection plate reflects heat rays radiated by the tubular heater into the heating compartment. The heat insulating layer covers the reflection plate.

### SUMMARY OF THE INVENTION

However, in the heating cooker described in JP H10-205772 A, heat of a heater is transmitted to the outside of a heating cooking compartment in some cases. Therefore, it is difficult to provide other members such as electronic components around the heater.

In view of the above problems, an object of the present disclosure is to provide a heating cooker capable of reducing transmission of heat of a heater unit to the outside of the heater unit and a heating cooking compartment.

According to one aspect of the present disclosure, a heating cooker includes a heating cooking compartment, a door, and a heater unit. The heating cooking compartment has an opening in a front wall. The door opens and closes the opening. The heater unit is disposed on an upper wall of the heating cooking compartment. The heater unit includes a heater configured to generate heat, a heat reflection plate covering an upper side of the heater, and a thermal shield plate covering an upper side of the heat reflection plate. Between the heat reflection plate and the thermal shield plate, an air layer is provided.

According to the heating cooker of the present disclosure, it is possible to reduce transmission of heat of the heater unit to the outside of the heater unit and the heating cooking compartment.

### BRIEF DESCRIPTION OF THE DRAWINGS

FIG. 1 is a perspective view illustrating a heating cooker according to an embodiment of the present disclosure;

FIG. 2 is a perspective view illustrating the heating cooker in a state where a housing is removed according to the embodiment;

FIG. 3 is a perspective view illustrating the heating cooker in a state where the housing is removed according to the embodiment;

FIG. 4 is a perspective view illustrating a door according to the embodiment;

FIG. 5 is a view illustrating a schematic cross section of the heating cooker according to the embodiment;

FIG. 6 is an enlarged view illustrating a schematic cross section of a first heater unit according to the embodiment;

FIG. 7 is a perspective view illustrating the heating cooker in a state where the housing is removed according to the embodiment;

FIG. 8 is an enlarged view illustrating a suction port of a first guide unit according to the embodiment;

FIG. 9 is a perspective view illustrating the heating cooker in a state where the housing is removed according to the embodiment;

FIG. 10 is a view illustrating a schematic cross section of the heating cooker according to the embodiment; and

FIG. 11 is a block diagram illustrating a configuration of the heating cooker according to the embodiment.

### DETAILED DESCRIPTION

Hereinafter, with reference to the drawings, an embodiment of a heating cooker according to the present disclosure will be described. Note that, in the drawings, the same or corresponding portions are denoted by the same reference numerals, and descriptions thereof will not be repeated.

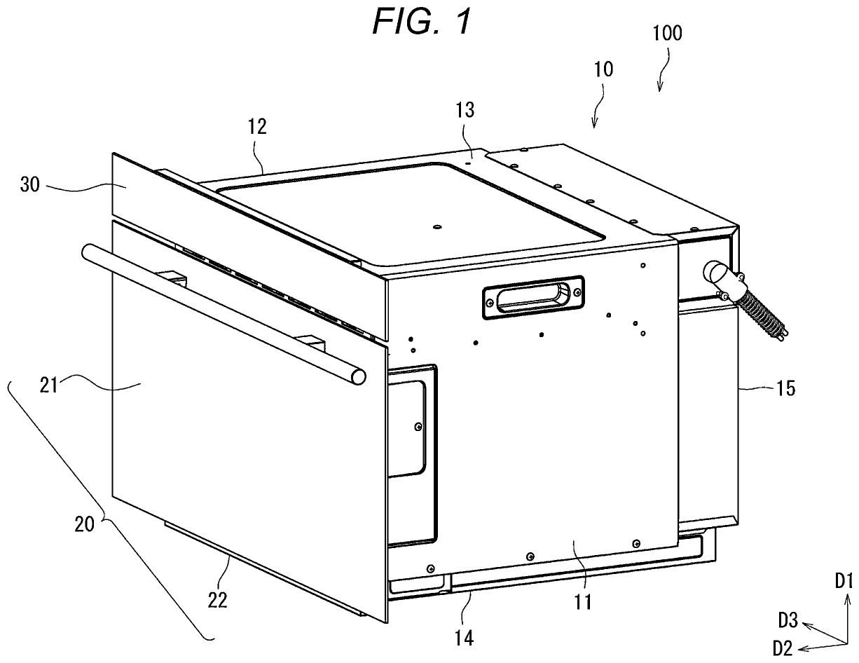

With reference to FIG. 1, a heating cooker 100 according to the embodiment will be described. FIG. 1 is a perspective view illustrating the heating cooker 100. In addition, FIG. 1 illustrates the external appearance of the heating cooker 100 when viewed diagonally from the upper right front. As illustrated in FIG. 1, the heating cooker 100 heats and cooks a heating-target object. The heating-target object is, for example, a food item. The heating cooker 100 includes a housing 10, a door 20, and an operation panel 30.

The operation panel 30 is a substantially rectangular plate-shaped member. The operation panel 30 receives an operation from a user. The operation includes, for example, a cooking method for heating and cooking a heating-target object. Specifically, the operation panel 30 includes a display unit. The display unit displays various items of information. Specifically, the display unit includes a liquid crystal panel.

In the embodiment, a side of the heating cooker 100 on which the operation panel 30 is disposed is defined as a front side of the heating cooker 100, and a side (back surface side) opposite to the front side is defined as a rear side of the heating cooker 100. In addition, when the heating cooker 100 is viewed from the front side, a right side is defined as a right side of the heating cooker 100, and a side opposite to the right side is defined as a left side of the heating cooker 100. In addition, in a direction orthogonal to a front-rear direction and a left-right direction of the heating cooker 100, a side on which the operation panel 30 is disposed is defined as an upper side of the heating cooker 100, and a side (bottom side) opposite to the upper side is defined as a lower side of the heating cooker 100. Note that, these directions and sides are not intended to limit directions and sides when the heating cooker 100 of the present disclosure is used. In the embodiment, a first direction D1 is an upward direction. A second direction D2 is a forward direction. A third direction D3 is a left direction.

The housing 10 is a box-shaped member. Specifically, the housing 10 has a right outer wall 11, a left outer wall 12, an upper outer wall 13, a lower outer wall 14, and a rear outer wall 15. The rear outer wall 15 intersects the second direction D2. The right outer wall 11 and the left outer wall 12 face each other in the third direction D3. The upper outer wall 13 and the lower outer wall 14 face each other in the first direction D1.

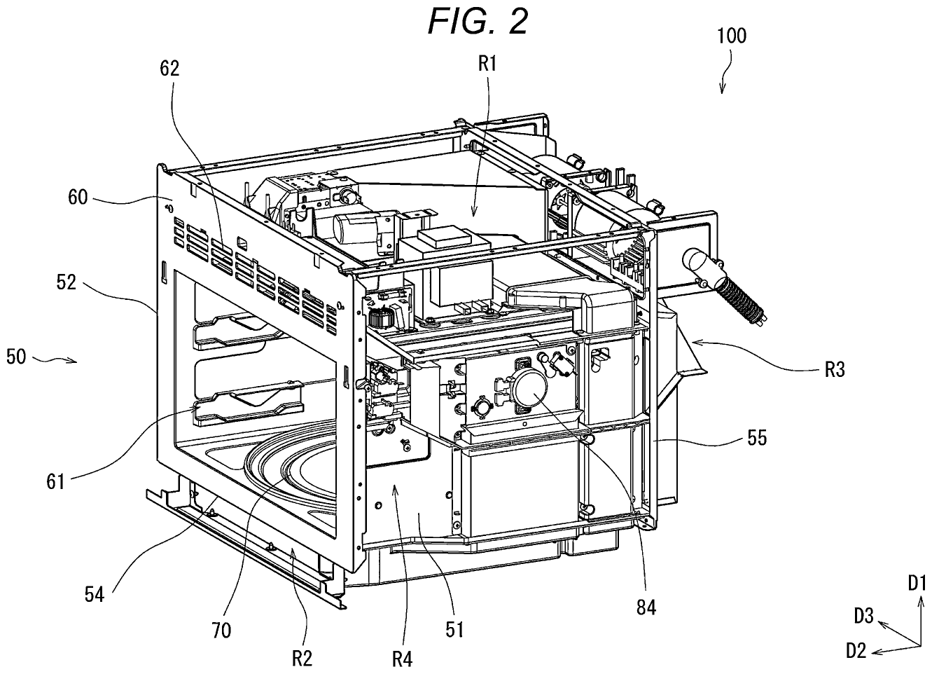

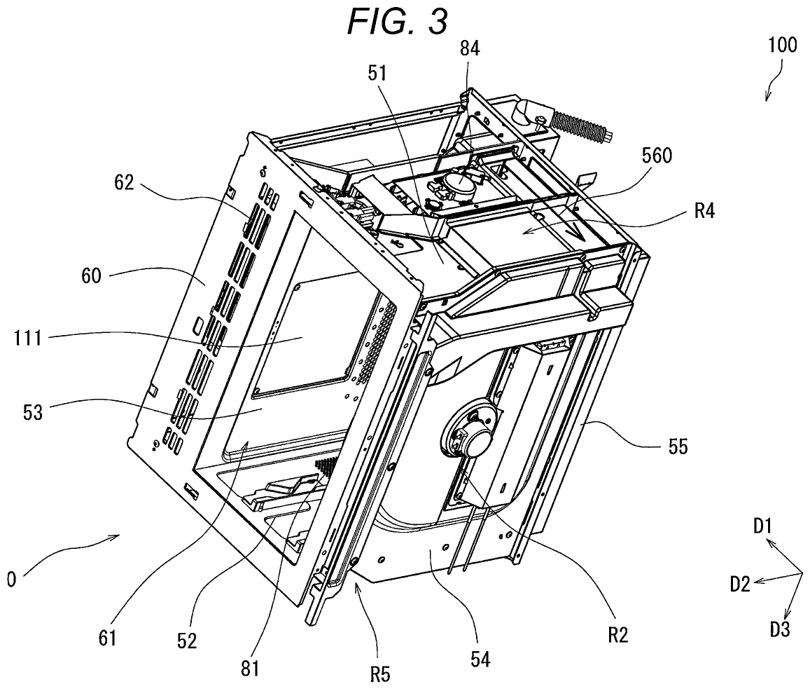

Continuing, a heating cooking compartment 50 will be described with reference to FIGS. 1 to 3. FIGS. 2 and 3 are perspective views illustrating the heating cooker 100 from which the housing 10 has been removed. FIG. 2 illustrates the external appearance of the heating cooker 100 when viewed diagonally from the upper right front. FIG. 3 illustrates the external appearance of the heating cooker 100 when viewed diagonally from the lower right front. As illustrated in FIGS. 1 to 3, the heating cooker 100 further includes the heating cooking compartment 50, a front wall 60, and a placement portion 70.

The heating cooking compartment 50 is accommodated in the housing 10. The heating cooking compartment 50 allows a heating-target object to be accommodated therein. The heating cooking compartment 50 has, for example, a substantially rectangular parallelepiped shape. Specifically, the heating cooking compartment 50 has a right wall 51, a left wall 52, an upper wall 53, a lower wall 54, and a rear wall 55. The rear wall 55 intersects the second direction D2. The right wall 51 and the left wall 52 face each other in the third direction D3. The upper wall 53 and the lower wall 54 face each other in the first direction D1. Examples of a material of each of the right wall 51, the left wall 52, the upper wall 53, the lower wall 54, and the rear wall 55 are metals.

The placement portion 70 is a dish-shaped member. The placement portion 70 is accommodated in the heating cooking compartment 50. The placement portion 70 is configured to allow the heating-target object to be placed. To be specific, the placement portion 70 is rotatable about a rotation axis in the first direction D1.

The heating cooker 100 further includes a first space R1, a second space R2, a third space R3, a fourth space R4, and a fifth space R5. The first space R1 is disposed between the upper outer wall 13 and the upper wall 53. The second space R2 is disposed between the lower outer wall 14 and the lower wall 54. The third space R3 is disposed between the rear outer wall 15 and the rear wall 55. The fourth space R4 is disposed between the right outer wall 11 and the right wall 51. The fifth space R5 is disposed between the left outer wall 12 and the left wall 52.

The front wall 60 is a plate-shaped member having a quadrangular ring shape. The front wall 60 faces the rear wall 55. In addition, the front wall 60 faces the rear outer wall 15. The front wall 60 has an opening 61 and a plurality of through-hole portions 62. The opening 61 allows an inside and an outside of the heating cooking compartment 50 to communicate with each other.

The plurality of through-hole portions 62 are positioned above the opening 61. Each of the plurality of through-hole portions 62 allows an inside and an outside of the first space R1 to communicate with each other. The plurality of through-hole portions 62 form eight columns. In each of the eight columns of the through-hole portions 62, three through-holes are arranged in a column in an up-down direction.

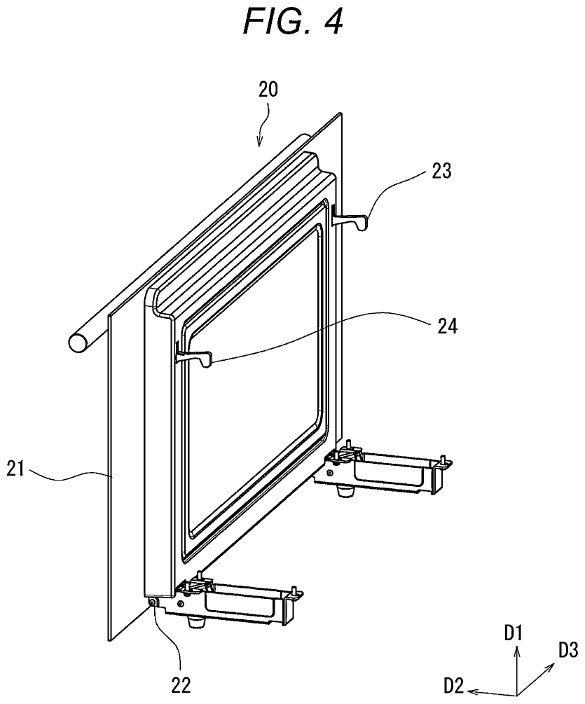

Continuing, the door 20 will be described with reference to FIGS. 1 to 4. FIG. 4 is a perspective view illustrating the door 20. As illustrated in FIGS. 1 to 4, the door 20 includes a substantially rectangular plate-shaped member 21 and a rotary shaft unit 22.

The rotary shaft unit 22 is positioned below the plate-shaped member 21. The plate- shaped member 21 opens and closes the opening 61. Specifically, the plate-shaped member 21 rotates about a rotation axis in the third direction D3. The plate-shaped member 21 opens the opening 61 in a state of being orthogonal to the first direction D1. On the other hand, the plate-shaped member 21 closes the opening 61 in a state of being orthogonal to the second direction D2.

To be specific, the door 20 includes a first connection member 23 and a second connection member 24. Both the first connection member 23 and the second connection member 24 connect the heating cooking compartment 50 and the door 20 when the door 20 is positioned at a closed position.

The first connection member 23 and the second connection member 24 are attached to the plate-shaped member 21. The first connection member 23 and the second connection member 24 face each other in the left-right direction. The first connection member 23 is attached to a left edge portion of a rear surface of the plate-shaped member 21. The second connection member 24 is attached to a right edge portion of the rear surface of the plate-shaped member 21.

For example, each of the first connection member 23 and the second connection member 24 has a hook member. The hook member is a plate-shaped member having a longitudinal direction thereof in the front-rear direction. The hook member includes a claw portion and a rotation pin portion. The rotation pin portion is positioned at one end portion of the hook member. The rotation pin portion rotates about a rotation axis extending in the third direction D3. On the other hand, the claw portion has a projecting portion projecting downward. The claw portion is positioned at the other end portion of the hook member. As a result, the claw portion is rotatable around the rotation pin portion.

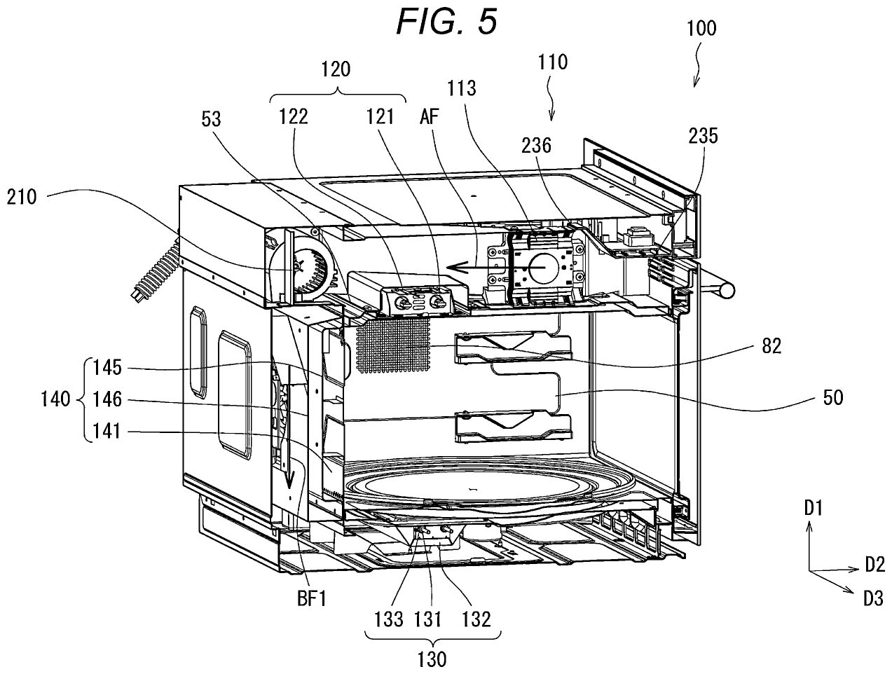

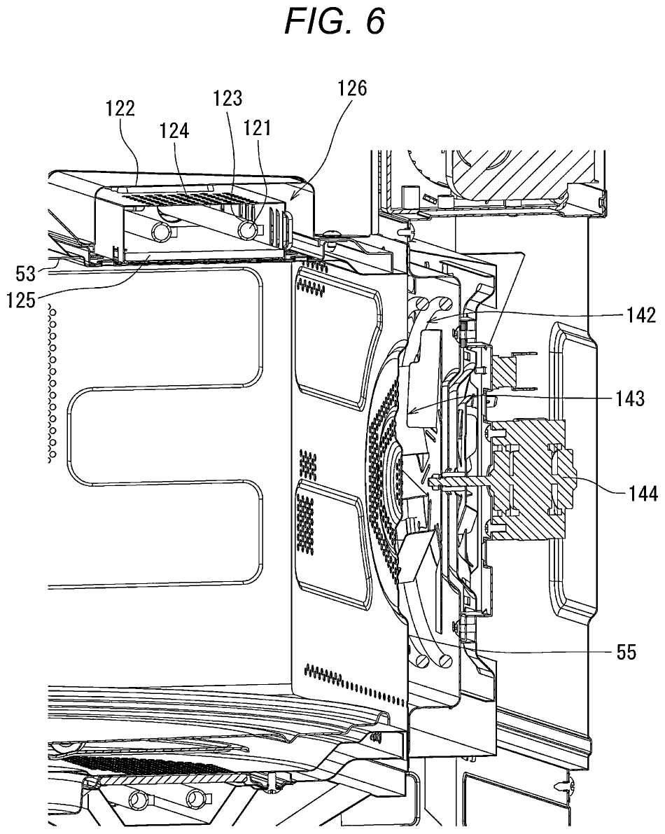

Next, the heating cooker 100 will be further described with reference to FIGS. 5 and 6. FIGS. 5 and 6 are views illustrating schematic cross sections of the heating cooker 100. To be specific, FIG. 5 is a cross-sectional view illustrating the heating cooker 100 cut along a plane orthogonal to the third direction D3. FIG. 6 is an enlarged cross-sectional view illustrating the first heater unit 120 cut along a plane orthogonal to the third direction D3.

As illustrated in FIGS. 5 and 6, the heating cooker 100 includes the first heater unit 120. The first heater unit 120 heats the heating-target object.

The first heater unit 120 is disposed on the upper wall 53 of the heating cooking compartment 50. The first heater unit 120 is, for example, a carbon heater. As a result, since the temperature rises quickly, the heating-target object can be cooked in a short time. Specifically, the first heater unit 120 includes a first heater 121, a first tube 123, a heat reflection plate 124, a thermal shield plate 122, and a glass plate 125.

The first heater 121 is, for example, a carbon heater. The first heater 121 in the state of power application generates heat.

The first tube 123 is made of glass. The first tube 123 accommodates the first heater 121. The first tube 123 extends in the third direction D3.

The heat reflection plate 124 covers an upper side of the first tube 123. The heat reflection plate 124 covers an upper side, a front side, and a rear side of the first heater 121. The heat reflection plate 124 reflects heat toward the heating cooking compartment 50.

The thermal shield plate 122 covers an upper side of the heat reflection plate 124. An air layer 126 is provided between the heat reflection plate 124 and the thermal shield plate 122. The thermal shield plate 122 covers an upper side, a front side, and a rear side of the heat reflection plate 124.

The glass plate 125 is a substantially rectangular plate-shaped member. The glass plate 125 is disposed between a lower side of the first tube 123 and the heating cooking compartment 50. In other words, the glass plate 125 separates the first tube 123 from the heating cooking compartment 50. As a result, the glass plate 125 transmits heat rays from the first heater 121 to the heating cooking compartment 50. On the other hand, the glass plate 125 prevents moisture and salt from moving from the heating cooking compartment 50 to the first tube 123. Accordingly, a devitrification phenomenon of the first tube 123 can be prevented.

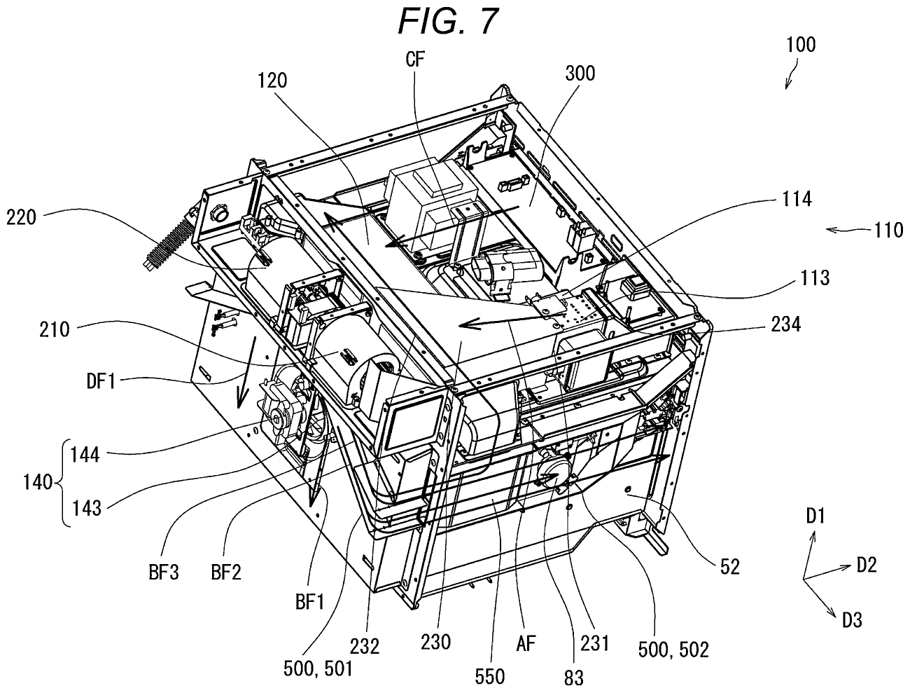

Continuing, the heating cooker 100 will be described in detail with reference to FIGS. 3, 5, and 7. FIG. 7 is a perspective view illustrating the heating cooker 100. To be specific, FIG. 7 illustrates the external appearance of the heating cooker 100 when viewed diagonally from the upper left rear. As illustrated in FIGS. 3, 5, and 7, the heating cooker 100 includes a microwave supply unit 110, a second heater unit 130, and an air blower 140. Each of the microwave supply unit 110, the second heater unit 130, and the air blower 140 heats the heating-target object.

First, the microwave supply unit 110 will be described. The microwave supply unit 110 supplies microwaves into the heating cooking compartment 50.

The microwave supply unit 110 is disposed on the upper wall 53 of the heating cooking compartment 50. Specifically, the microwave supply unit 110 is positioned above the heating cooking compartment 50 with the upper wall 53 interposed therebetween. The microwave supply unit 110 includes a partition member 111, a radiation chamber, a magnetron 113, and a waveguide 114.

The magnetron 113 is disposed closer to the front wall 60 than the first heater unit 120. The magnetron 113 generates microwaves. The waveguide 114 propagates the microwaves generated by the magnetron to the radiation chamber, and supplies the microwaves to the inside of the heating cooking compartment 50.

The partition member 111 is disposed between the radiation chamber and the upper wall 53 of the heating cooking compartment 50. Examples of a material of the partition member 111 are non-metals, and include a ceramic or mica. As a result, since the material of the partition member 111 contains a ceramic or mica, the partition member 111 transmits microwaves. On the other hand, materials of the radiation chamber and the waveguide 114 include metals.

In addition, the heating cooking compartment 50 further includes an intake hole portion 81, an exhaust hole portion 82, an intake damper unit 83, and an exhaust damper unit 84.

The intake hole portion 81 allows the inside and the outside of the heating cooking compartment 50 to communicate with each other. Specifically, the intake hole portion 81 is disposed on the left wall 52. The intake hole portion 81 has, for example, a quadrangular shape. Specifically, the intake hole portion 81 is, for example, a group of a plurality of punched holes. A punched hole has, for example, a circular shape. A diameter of a punched hole of the intake hole portion 81 is, for example, 3.4 mm in order to prevent microwaves from leaking.

The intake damper unit 83 opens and closes the intake hole portion 81. The intake damper unit 83 is attached to an outer side of the left wall 52. For example, in a case where the intake damper unit 83 opens the intake hole portion 81, the inside and the outside of the heating cooking compartment 50 communicate with each other. As a result, air is guided to the intake hole portion 81. On the other hand, in a case where the intake damper unit 83 closes the intake hole portion 81, the inside and the outside of the heating cooking compartment 50 do not communicate with each other. As a result, air is not guided to the intake hole portion 81.

In addition, the exhaust hole portion 82 allows the inside and the outside of the heating cooking compartment 50 to communicate with each other. Specifically, the exhaust hole portion 82 is disposed on the right wall 51. The exhaust hole portion 82 has, for example, a quadrangular shape. Specifically, the exhaust hole portion 82 is, for example, a group of a plurality of punched holes. A punched hole has, for example, a circular shape. A diameter of a punched hole of the exhaust hole portion 82 is, for example, 3.4 mm in order to prevent microwaves from leaking.

The exhaust damper unit 84 opens and closes the exhaust hole portion 82. The exhaust damper unit 84 is attached to an outer side of the right wall 51. For example, in a case where the exhaust damper unit 84 opens the exhaust hole portion 82, the inside and the outside of the heating cooking compartment 50 communicate with each other. On the other hand, in a case where the exhaust damper unit 84 closes the exhaust hole portion 82, the inside and the outside of the heating cooking compartment 50 do not communicate with each other.

Continuing, a flow of the air will be described in detail. First, the intake damper unit 83 opens the intake hole portion 81, and the exhaust damper unit 84 opens the exhaust hole portion 82. As a result, air is guided to the intake hole portion 81. The air is blown into the heating cooking compartment 50 through the intake hole portion 81. The air blown from the intake hole portion 81 moves into the heating cooking compartment 50 in a direction opposite to the third direction D3. Thereafter, the air is discharged from the exhaust hole portion 82 to the outside of the heating cooking compartment 50.

Next, the second heater unit 130 will be described. The second heater unit 130 is, for example, a sheathed heater. The second heater unit 130 is disposed on the lower wall 54 of the heating cooking compartment 50. Specifically, the second heater unit 130 includes a second heater 131, a second tube 133, and a second heater case 132.

The second heater 131 is, for example, a nichrome wire. The second heater 131 in the state of power application generates heat. An output of the second heater 131 is lower than an output of the first heater 121.

The second tube 133 is made of metal. The second tube 133 accommodates the second heater 131. The second tube 133 extends in the third direction D3.

The second heater case 132 covers an upper side, a front side, and a rear side of the second tube 133. The second heater case 132 is made of a material including metal.

Next, the air blower 140 will be described. The air blower 140 is configured to supply hot air into the heating cooking compartment 50. The air blower 140 is disposed on the rear wall 55. Specifically, the air blower 140 is positioned behind the heating cooking compartment 50 with the rear wall 55 interposed therebetween.

Specifically, the air blower 140 includes an air blowing chamber 141, a third heater 142, a centrifugal fan 143, a drive unit 144, a partition member 145, and a heat shield plate 146. The air blowing chamber 141 is, for example, a box-shaped member made of metal. The centrifugal fan 143 has a plurality of blades.

The third heater 142 and the centrifugal fan 143 are accommodated in the air blowing chamber 141. The third heater 142 heats air inside the air blowing chamber 141 to generate hot air. Specifically, the third heater 142 has an annular shape when viewed from the front side toward the rear side. The third heater 142 is disposed along an outer circumference of the centrifugal fan 143.

The rear wall 55 has a suction hole portion and a blow-out hole portion. To be specific, the suction hole portion is, for example, a group of a plurality of punched holes. Similarly, the blow-out hole portion is also, for example, a group of a plurality of punched holes. A punched hole has, for example, a circular shape. A diameter of a punched hole of each of the suction hole portion and the blow-out hole portion is, for example, 3.4 mm in order to prevent microwaves from leaking.

The partition member 145 is, for example, a plate-shaped member made of metal. The partition member 145 has, for example, an oblong shape when viewed from the front side toward the rear side. The partition member 145 is disposed on substantially the entire surface of the rear wall 55. Specifically, the partition member 145 is positioned on the outward side from the rear wall 55.

The heat shield plate 146 is, for example, a plate-shaped member made of metal. The heat shield plate 146 is, for example, a plate-shaped member having a quadrangular ring shape when viewed from the front side toward the rear side. The heat shield plate 146 is positioned on the outward side from the partition member 145.

The drive unit 144 is positioned an outward side from the air blowing chamber 141. Specifically, the drive unit 144 is positioned on an outward side from the heat shield plate 146, and a shaft portion of the drive unit 144 penetrates the partition member 145 and the heat shield plate 146 and is connected to the centrifugal fan 143. The drive unit 144 drives the centrifugal fan 143. The drive unit 144 includes, for example, a motor.

The air blower 140 draws in hot air in the heating cooking compartment 50 through the suction hole portion, and blows hot air into the heating cooking compartment 50 through the blow-out hole portion. To be more specific, the air blower 140 draws in hot air from a central portion inside the heating cooking compartment 50 and blows the hot air to a peripheral border portion inside the heating cooking compartment 50. As a result, the entire inside of the heating cooking compartment 50 can be heated by driving the air blower 140.

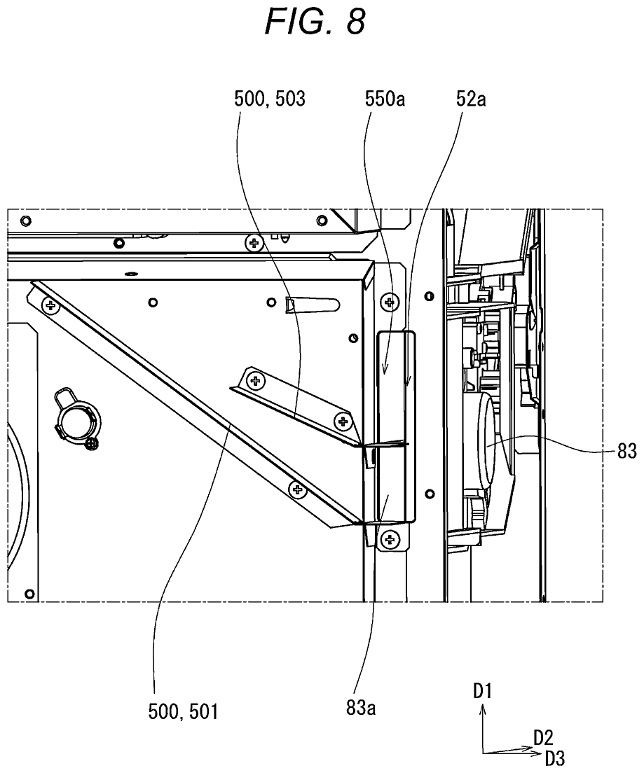

A first fan 210, a first wind direction plate 500, and a first guide unit 550 will be described with reference to FIGS. 7 and 8. FIG. 8 is an enlarged view illustrating a suction port of the first guide unit 550 according to the embodiment. As illustrated in FIGS. 7 and 8, the heating cooker 100 further includes the first fan 210, the first wind direction plate 500, and the first guide unit 550. For example, the first fan 210 is a Sirocco fan. The first fan 210 is disposed on the upper wall 53 of the heating cooking compartment 50. In addition, the first fan 210 is disposed between the rear wall 55 of the heating cooking compartment 50 and the rear outer wall 15 of the housing 10. Specifically, the first fan 210 is disposed in a region in which the first space R1 and the third space R3 overlap each other.

To be specific, the first fan 210 is positioned at the same height as the plurality of through-hole portions 62 are. The first fan 210 generates an air flow between the upper wall 53 of the heating cooking compartment 50 and the upper outer wall 13 of the housing 10. The first fan 210 takes air outside the heating cooker 100 into the first space R1. In addition, the first fan 210 generates an air flow between the rear wall 55 of the heating cooking compartment 50 and the rear outer wall 15 of the housing 10. The first fan 210 discharges the air in the first space R1 into the third space R3.

The first guide unit 550 guides air flows to the first heater unit 120 and the intake damper unit 83. The first guide unit 550 guides the air flows from the first fan 210 toward the first heater unit 120 and the intake damper unit 83. Specifically, the first guide unit 550 is a cylindrical body. The cylindrical body has a suction port 550a, a suction port 83a, and respective blow-out ports. The cylindrical body is disposed on the left wall 52. The suction port 550a and the suction port 83a are open in a direction opposite to the second direction D2. The blow-out ports are open toward the first heater unit 120 and the intake damper unit 83, respectively. To be specific, the first guide unit 550 guides an air flow between the heat reflection plate 124 and the thermal shield plate 122.

The first wind direction plate 500 includes a first skew plate 501, a second skew plate 503, and a horizontal plate 502.

The first skew plate 501 guides a part of the air flow to the suction port 83a of the first guide unit 550 leading to the intake hole portion 81 of the intake damper unit 83, and guides the remaining part of the air flow to a suction port 52a leading to the left wall 52. Specifically, the first skew plate 501 is disposed on the heat shield plate 146. The first skew plate 501 is provided upright on the heat shield plate 146. The first skew plate 501 extends from below the first fan 210 toward the left wall 52.

The second skew plate 503 guides a part of the air flow to the suction port 550a of the first guide unit 550 leading to the first heater unit 120, and guides the remaining part of the air flow to the suction port 52a leading to the left wall 52. Specifically, the second skew plate 503 is disposed on the heat shield plate 146. The second skew plate 503 is provided upright on the heat shield plate 146. The second skew plate 503 is positioned on the upper side from the first skew plate 501. The second skew plate 503 extends from below the first fan 210 toward the left wall 52.

The horizontal plate 502 is disposed on the left wall 52. The horizontal plate 502 is provided upright on the left wall 52. The horizontal plate 502 passes below the intake damper unit 83 from the rear wall 55 and extends toward the front wall 60.

Here, a flow of air generated by driving of the first fan 210 will be described. When driven, the first fan 210 generates an intake air flow AF. The intake air flow AF passes through the plurality of through-hole portions 62 from the outside of the heating cooker 100, circulates in the first space R1 between the microwave supply unit 110 and the upper outer wall 13 in a direction opposite to the second direction D2, and flows toward the first heater unit 120. At this time, the intake air flow AF cools the magnetron 113 of the microwave supply unit 110. The intake air flow AF that has cooled the magnetron 113 circulates in the first space R1 between the first heater unit 120 and the upper outer wall 13 in a direction opposite to the second direction D2 and flows toward the first fan 210. At this time, the intake air flow AF cools the thermal shield plate 122 of the first heater unit 120. In other words, the first fan 210 generates an air flow that circulates through the magnetron 113 and the first heater unit 120 in this order.

In addition, when driven, the first fan 210 generates a blown air flow BF1, a blown air flow BF2, and a blown air flow BF3. The blown air flow BF1 is blown downward. The blown air flow BF1 circulates downward in the third space R3 between the air blower 140 and the rear outer wall 15. At this time, the blown air flow BF1 cools the drive unit 144 of the air blower 140.

The blown air flow BF1 reaching the lower outer wall 14 circulates in the second space R2 between the lower outer wall 14 and the second heater unit 130 in the second direction D2. At this time, the blown air flow BF1 cools the second heater case 132 of the second heater unit 130. In other words, the first fan 210 generates an air flow that circulates through the magnetron 113, the first heater unit 120, and the second heater unit 130 in this order. The blown air flow BF1 that has cooled the second heater unit 130 is discharged to the outside of the heating cooker 100.

In addition, the blown air flow BF2 reaches the first skew plate 501. The blown air flow BF2 reaching the first skew plate 501 is guided to the left wall 52 along the first skew plate 501. A part of the blown air flow BF2 guided to the left wall 52 is guided to the suction port 83a of the first guide unit 550 leading to the intake hole portion 81 of the intake damper unit 83. In addition, the remaining part of the blown air flow BF2 is guided to the outside of the first guide unit 550 and circulates in the second direction D2 along the horizontal plate 502.

Further, the blown air flow BF3 reaches the second skew plate 503. The blown air flow BF3 reaching the second skew plate 503 is guided to the left wall 52 along the second skew plate 503. A part of the blown air flow BF3 guided to the left wall 52 circulates in the first guide unit 550. The blown air flow BF3 that has circulated in the first guide unit 550 circulates between the heat reflection plate 124 and the thermal shield plate 122 in a direction opposite to the third direction D3. At this time, the blown air flow BF3 cools the heat reflection plate 124. The blown air flow BF3 that has cooled the heat reflection plate 124 is guided to the right wall 51. In addition, the remaining part of the blown air flow BF2 is guided to the left wall 52 circulates in the second direction D2 along the horizontal plate 502.

As described above with reference to FIGS. 1 to 8, according to the heating cooker 100, since the air layer 126 is provided between the heat reflection plate 124 and the thermal shield plate 122, transmission of the heat of the first heater unit 120 to the outside of the first heater unit 120 and the heating cooking compartment 50 can be reduced. In addition, since the first guide unit 550 guides the air flow to the first heater unit 120, it is possible to further reduce transmission of the heat of the first heater unit 120 to the outside of the first heater unit 120 and the heating cooking compartment 50.

In addition, since the first guide unit 550 guides the air flow between the heat reflection plate 124 and the thermal shield plate 122, it is possible to further reduce transmission of the heat of the first heater unit 120 to the outside of the first heater unit 120 and the heating cooking compartment 50. In addition, since the first guide unit 550 guides the air flow between the heat reflection plate 124 and the thermal shield plate 122, other members can be disposed around the first heater unit 120 even if the first heater unit 120 is a carbon heater having a high output. Specifically, other members can be disposed on the upper wall 53 of the heating cooking compartment 50 on which the first heater unit 120 is disposed.

Further, the first fan 210 generates the air flow that circulates through the magnetron 113 and the first guide unit 550 in this order, and thus can efficiently cool the magnetron 113 and the first heater unit 120 disposed on the upper wall 53 of the heating cooking compartment 50.

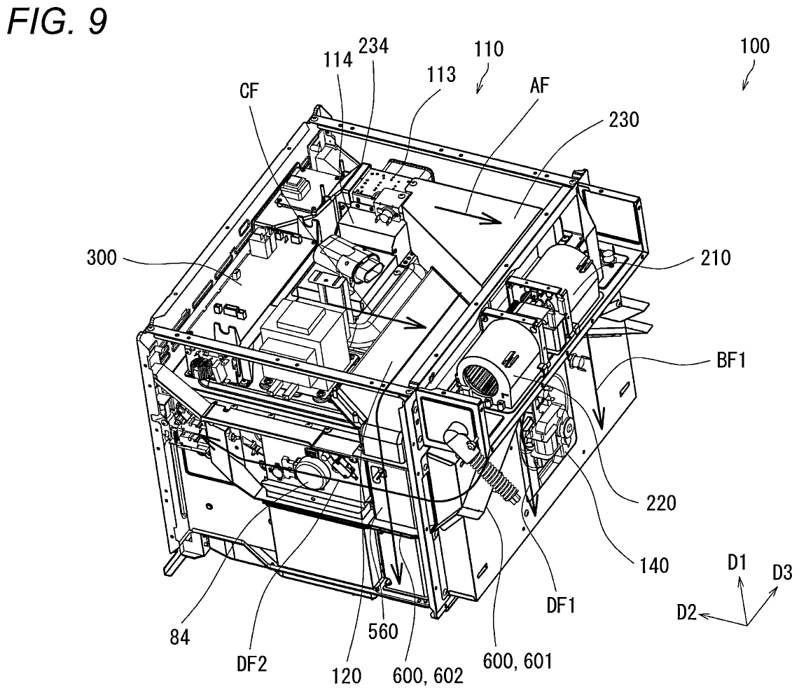

A second guide unit 560 will be described with reference to FIGS. 3 and 7 to 9. FIG. 9 is a perspective view illustrating the heating cooker in a state where the housing is removed according to the embodiment. As illustrated in FIGS. 3 and 7 to 9, the heating cooker 100 further includes the second guide unit 560. The second guide unit 560 guides an air flow from the first heater unit 120 to the lower wall 54.

The second guide unit 560 is a cylindrical body. The cylindrical body has a suction port and a blow-out port. The cylindrical body is disposed on the right wall 51. The suction port is connected to the first heater unit 120. The blow-out port is close to the lower wall 54.

Here, a flow of air generated by driving of the first fan 210 will be described. When driven, the first fan 210 generates the blown air flow BF1, the blown air flow BF2, and the blown air flow BF3. The blown air flow BF3 reaches the first skew plate 501. The blown air flow BF3 reaching the first skew plate 501 is guided to the left wall 52 along the first skew plate 501. The blown air flow BF3 guided to the left wall 52 circulates in the first guide unit 550. The blown air flow BF3 that has circulated in the first guide unit 550 circulates between the heat reflection plate 124 and the thermal shield plate 122 in a direction opposite to the third direction D3. At this time, the blown air flow BF3 cools the heat reflection plate 124.

The blown air flow BF3 that has cooled the heat reflection plate 124 circulates inside the second guide unit 560 in a direction opposite to the first direction D1.

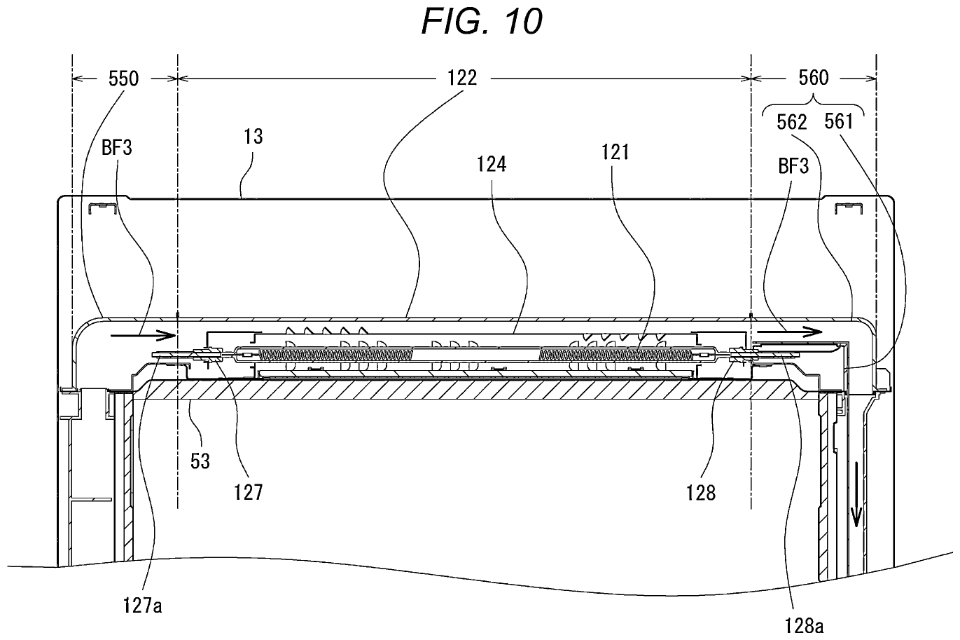

Next, the heating cooker 100 will be further described with reference to FIG. 10. FIG. 10 is a view illustrating a schematic cross section of the heating cooker 100. To be specific, FIG. 10 is a cross-sectional view illustrating the heating cooker 100 cut along a plane orthogonal to the second direction D2. As illustrated in FIG. 10, the first heater unit 120 further includes a first lead wire drawing portion 127 and a second lead wire drawing portion 128.

The second guide unit 560 includes an inner second guide unit 561 and an outer second guide unit 562. The outer second guide unit 562 is disposed on an outward side from the inner second guide unit 561. The air that has passed through the first heater unit 120 circulates between an inside of the outer second guide unit 562 and an outer side of the inner second guide unit 561. The air circulating in the first heater unit 120 mainly passes between the heat reflection plate 124 and the thermal shield plate 122, but since the heat reflection plate 124 has an opening portion, a part of the air also passes through the inside of the heat reflection plate 124. On the other hand, the air that has passed through the first heater unit 120 does not circulate inside the inner second guide unit 561.

Power is supplied to the first heater 121 from a power source (not illustrated) by the first lead wire drawing portion 127 and the second lead wire drawing portion 128. The first lead wire drawing portion 127 is connected to one end portion of the first heater 121. Specifically, the first lead wire drawing portion 127 is connected to the third direction D3 side of the first heater 121. A first lead wire 127a drawn out from the first lead wire drawing portion 127 is disposed in the first guide unit 550. Accordingly, the first lead wire 127a comes into contact with the air that has not yet passed between the heat reflection plate 124 and the thermal shield plate 122. Since the air that has not yet passed between the heat reflection plate 124 and the thermal shield plate 122 has a low temperature, there is no problem in heat resistance even if the first lead wire 127a is disposed in the first guide unit 550.

The second lead wire drawing portion 128 is connected to the other end portion of the first heater 121. Specifically, the second lead wire drawing portion 128 is connected to the first heater 121 on a side opposite to the third direction D3. Since the air that has passed between the heat reflection plate 124 and the thermal shield plate 122 has a high temperature, a problem in heat resistance may arise when a second lead wire 128a drawn out from the second lead wire drawing portion 128 is disposed in the second guide unit 560. Therefore, the second lead wire 128a is disposed outside the second guide unit 560. Accordingly, the second lead wire 128a does not come into contact with the air that has passed between the heat reflection plate 124 and the thermal shield plate 122.

Continuing, a second fan 220 will be described with reference to FIGS. 7 and 9. As illustrated in FIGS. 7 and 9, the heating cooker 100 further includes the second fan 220, a second wind direction plate 600, and a control board 300.

The control board 300 includes a storage 310 and a controller 320. The storage 310 includes a random access memory (RAM) and a read only memory (ROM). The storage 310 stores control programs for controlling an operation of each component of the heating cooker 100.

The controller 320 is a hardware circuit including a processor such as a central processing unit (CPU). The controller 320 executes the control programs stored in the storage 310.

For example, the second fan 220 is a Sirocco fan. The first fan 210 and the second fan 220 are arranged side by side in the left-right direction. The second fan 220 is disposed on the upper wall 53 of the heating cooking compartment 50. In addition, the second fan 220 is disposed between the rear wall 55 of the heating cooking compartment 50 and the rear outer wall 15 of the housing 10. Specifically, the second fan 220 is disposed in the region in which the first space R1 and the third space R3 overlap each other.

To be specific, the second fan 220 is positioned at the same height as the plurality of through-hole portions 62 are. The second fan 220 generates an air flow between the upper wall 53 of the heating cooking compartment 50 and the upper outer wall 13 of the housing 10. The second fan 220 takes air outside the heating cooker 100 into the first space R1. In addition, the second fan 220 generates an air flow between the rear wall 55 of the heating cooking compartment 50 and the rear outer wall 15 of the housing 10. The second fan 220 discharges the air in the first space R1 into the third space R3.

The second wind direction plate 600 guides an air flow to the exhaust damper unit 84. Specifically, the second wind direction plate 600 includes a skew plate 601 and a horizontal plate 602.

The skew plate 601 is disposed on the rear wall 55. The skew plate 601 is provided upright on the heat shield plate 146. The skew plate 601 extends from below the second fan 220 toward the right wall 51.

The horizontal plate 602 is disposed on the right wall 51. The horizontal plate 602 is provided upright on the right wall 51. The horizontal plate 602 passes below the exhaust damper unit 84 from the rear wall 55 and extends toward the front wall 60.

Here, a flow of air generated by driving of the second fan 220 will be described. When driven, the second fan 220 generates an intake air flow CF. The intake air flow CF passes through the plurality of through-hole portions 62 from the outside of the heating cooker 100, circulates in the first space R1 between the control board 300 and the upper outer wall 13 in the direction opposite to the second direction D2, and flows toward the first heater unit 120. At this time, the intake air flow CF cools the control board 300. The intake air flow CF that has cooled the control board 300 circulates in the first space R1 between the first heater unit 120 and the upper outer wall 13 in the direction opposite to the second direction D2 and flows toward the second fan 220. At this time, the intake air flow CF cools the thermal shield plate 122. In other words, the second fan 220 generates an air flow that circulates through the control board 300 and the first heater unit 120 in this order.

In addition, when driven, the second fan 220 generates a blown air flow DF1 and a blown air flow DF2. The blown air flow DF1 is blown downward. The blown air flow DF1 circulates downward in the third space R3 between the air blower 140 and the rear outer wall 15. At this time, the blown air flow DF1 cools the drive unit 144 of the air blower 140.

The blown air flow DF1 reaching the lower outer wall 14 circulates in the second space R2 between the lower outer wall 14 and the second heater unit 130 in the second direction D2. At this time, the blown air flow DF1 cools the second heater case 132. In other words, the second fan 220 generates an air flow that circulates through the control board 300, the first heater unit 120, and the second heater unit 130 in this order. The blown air flow DF1 that has cooled the second heater unit 130 is discharged to the outside of the heating cooker 100.

In addition, the blown air flow DF2 reaches the skew plate 601. The blown air flow DF2 reaching the skew plate 601 is guided to the right wall 51 along the skew plate 601. The blown air flow DF2 guided to the right wall 51 circulates in the second direction D2 along the horizontal plate 602. At this time, the blown air flow DF2 cools the exhaust damper unit 84. The blown air flow DF2 that has cooled the exhaust damper unit 84 is discharged to the outside of the heating cooker 100.

As illustrated in FIGS. 7 and 9 again, the heating cooker 100 further includes a front duct member 234 and a rear duct member 230.

The front duct member 234 extends from the front wall 60 toward the magnetron 113. Specifically, the front duct member 234 is a groove-shaped member having a substantially U-shaped cross section and a longitudinal direction in the second direction D2. The front duct member 234 is disposed in the first space R1. The front duct member 234 faces the upper wall 53.

To be specific, the front duct member 234 has a suction port 235 and a blow-out port 236. The suction port 235 is open in the second direction D2. The blow-out port 236 is open in the direction opposite to the second direction D2. The suction port 235 is smaller in size than the blow-out port 236. The blow-out port 236 is positioned in front of the magnetron 113. The blow-out port 236 is close to the magnetron 113.

The rear duct member 230 extends from the magnetron 113 toward the first fan 210. Specifically, the rear duct member 230 is a groove-shaped member having a substantially U-shaped cross section and a longitudinal direction in the second direction D2. The rear duct member 230 faces the upper wall 53.

To be specific, the rear duct member 230 has a suction port 231 and a blow-out port 232. The suction port 231 is open in the second direction D2. The blow-out port 232 is open in the direction opposite to the second direction D2. The suction port 231 is smaller in size than the blow-out port 232. The blow-out port 232 is positioned in front of the first fan 210. The blow-out port 232 is close to the first fan 210.

Here, a flow of air generated by driving of the first fan 210 will be described. When driven, the first fan 210 generates an intake air flow AF. The intake air flow AF passes through the plurality of through-hole portions 62 from the outside of the heating cooker 100, circulates in the front duct member 234 in the direction opposite to second direction D2, and flows into rear duct member 230. At this time, the intake air flow AF cools the magnetron 113 of the microwave supply unit 110. The intake air flow AF that has cooled the magnetron 113 circulates in the rear duct member 230 in the direction opposite to the second direction D2 and flows toward the first fan 210. At this time, the intake air flow AF cools the thermal shield plate 122. In other words, the first fan 210 generates an air flow that circulates through the magnetron 113 and the first heater unit 120 in this order.

As described above with reference to FIGS. 7 and 9, since the heating cooker 100 further includes the front duct member 234 and the rear duct member 230, the magnetron 113 disposed on the upper wall 53 of the heating cooking compartment 50 can be more efficiently cooled.

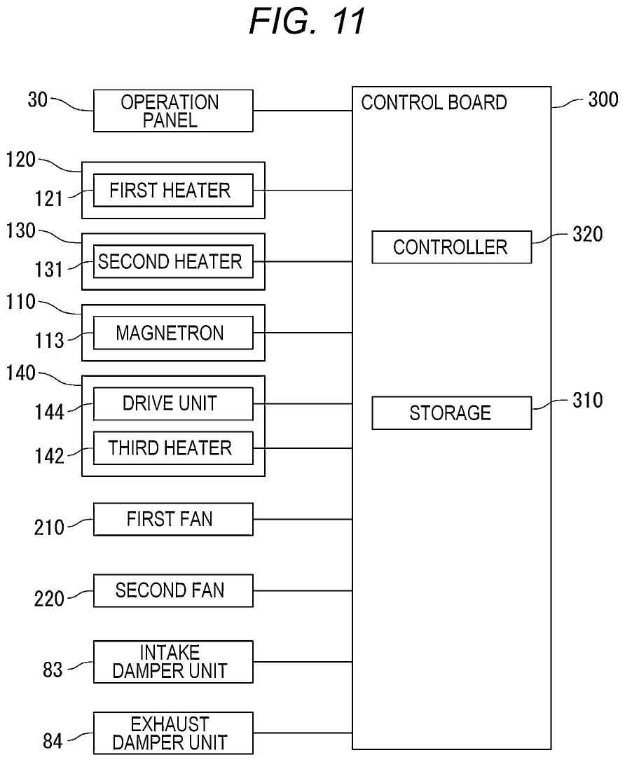

With reference to FIG. 11, a configuration of the heating cooker 100 will be described in detail. FIG. 11 is a block diagram illustrating a configuration of the heating cooker according to the embodiment. In the embodiment, the heating cooker 100 has, as heating cooking modes, a “microwave heating mode”, a “hot air circulation heating mode”, and a “grill heating mode”. The “microwave heating mode” is a mode for heating and cooking a heating-target object mainly by radiating microwaves into the heating cooking compartment 50. The “grill heating mode” means a mode for heating and cooking a heating-target object mainly by causing heat generated from the first heater unit 120 and the second heater unit 130 to radiate to the heating-target object. The “hot air circulation heating mode” is a mode for heating and cooking a heating- target object mainly by circulating hot air throughout the heating cooking compartment 50 to ensure a uniform temperature in the heating cooking compartment 50.

The controller 320 executes control programs stored in the storage 310, thereby controlling driving of the microwave supply unit 110, driving of the air blower 140, driving of the first heater unit 120, driving of the second heater unit 130, driving of the first fan 210, and driving of the second fan 220.

To be specific, the controller 320 controls the operation panel 30, the magnetron 113, the first heater 121, the second heater 131, the third heater 142, the drive unit 144, the first fan 210, the second fan 220, the intake damper unit 83, and the exhaust damper unit 84. For example, in the case where the “microwave heating mode” is selected, the controller 320 drives the magnetron 113, the first fan 210, the second fan 220, the intake damper unit 83, and the exhaust damper unit 84. In addition, in the case where the “grill heating mode” is selected, the controller 320 drives the first heater 121, the second heater 131, the first fan 210, and the second fan 220. Further, in the case where the “hot air circulation heating mode” is selected, the controller 320 drives the drive unit 144, the first fan 210, and the second fan 220, and drives at least one of the first heater 121, the second heater 131, and the third heater 142.

The embodiment of the present disclosure has been described above with reference to the drawings. However, the present disclosure is not limited to the above embodiment, and can be implemented in various aspects without departing from the gist thereof. For easy understanding, the drawings schematically illustrate the individual components mainly, and the thicknesses, lengths, number, and the like of the individual components illustrated in the drawings are different from actual ones for convenience of preparation of the drawings. In addition, the materials, shapes, dimensions, and the like of the individual components illustrated in the above embodiment are merely examples, and are not particularly limited, and various modifications can be made without substantially departing from the effects of the present disclosure.

The present disclosure provides a heating cooker, and has industrial applicability.

What is claimed is:

1. A heating cooker comprising:
a heating cooking compartment having an opening in a front wall;
a door configured to open and close the opening; and
a heater unit disposed on an upper wall of the heating cooking compartment,
wherein
the heater unit includes
a heater configured to generate heat,
a heat reflection plate covering an upper side of the heater, and
a thermal shield plate covering an upper side of the heat reflection plate, and
between the heat reflection plate and the thermal shield plate, an air layer is provided.

2. The heating cooker according to claim 1, further comprising a fan configured to generate an air flow,
wherein the fan blows air to the air layer.

3. The heating cooker according to claim 2, further comprising a first guide unit configured to guide the air flow to the air layer.

4. The heating cooker according to claim 1, further comprising:
a tube configured to accommodate the heater, the tube being made of glass; and
a glass plate provided between the tube and the heating cooking compartment,
wherein the glass plate separates the tube from the heating cooking compartment.

5. The heating cooker according to claim 3, further comprising a second guide unit configured to allow the air flow that has passed through the air layer to circulate,
wherein
the heater unit further includes
a first lead wire drawn out from a first lead wire drawing portion connected to one end portion of the heater, and
a second lead wire drawn out from a second lead wire drawing portion connected to another end portion of the heater,
the first lead wire is disposed in the first guide unit, and
the second lead wire is disposed outside the second guide unit.
